(19) United States
(12) Patent Application Publication
(10) Pub. No.: US 2024/0172276 A1
(43) Pub. Date: May 23, 2024

(54) Channel Access Mechanism For Sidelink In Unlicensed Spectrum

(71) Applicant: Charter Communications Operating, LLC, St. Louis, MO (US)

(72) Inventor: Amitav Mukherjee, Elk Grove, CA (US)

(21) Appl. No.: 17/990,175

(22) Filed: Nov. 18, 2022

(51) Int. Cl. H04W 74/08; H04L 1/18

(52) U.S. Cl. CPC H04W 74/0808; H04L 1/1822; H04L 1/1812

(57) ABSTRACT

A communications device determines a contention window value, e.g., an adjusted contention window value, to be used in upcoming sidelink access operations for unlicensed spectrum, e.g., in LBT channel sensing operations, prior to being allowed to transmit sidelink signals in unlicensed spectrum. When the communications device is operating in a unicast or groupcast transmit mode with regard to PSSCH signals, the communications device implements a HARQ response based contention window update process. When the communications device is operating in a broadcast transmit mode with regard to sidelink signals, the communications device implements a SL-RSRP evaluation based contention window update process.

### FIELD

The present application relates to communications and, more particularly, to methods and apparatus for supporting efficient channel access for sidelink communications in unlicensed spectrum.

### BACKGROUND

Channel access mechanisms were introduced in 3rd Generation Partnership Project (3GPP) Releases 13-15 for Long-Term Evolution (LTE) Licensed Assisted Access (LAA) and its enhancements enhanced LAA/further enhanced LAA (eLAA/FeLAA) that specified downlink (DL) and uplink (UL) LTE operation in unlicensed spectrum, primarily 5 GHz. The channel access schemes are similar to carrier sense multiple access with collision avoidance (CSMA/CA_ and Enhanced Distributed Channel Access (EDCA) channel access used in IEEE 802.11ac/ax.

Closely related channel access schemes were introduced in Release 16 for 5G New Radio in unlicensed spectrum (NR-U) for operation in 5 GHz and 6 GHz unlicensed spectrum.

In both LTE LAA and NR-U, DL and UL channel access for shared data channels (physical downlink shared channel (PDSCH), physical uplink shared channel (PUSCH)) employ a random backoff for channel sensing prior to transmission. The backoff is drawn from a binary exponential contention window (CW). The contention window size has a minimum limit CWmin and a maximum limit CWmax.

On the DL, for LTE LAA the CW is reset to CWmin if at least 80% of the Hybrid Automatic Repeat Request (HARQ) acknowledgment (ACK) feedback bits for the last PDSCH subframe were ACKs. For NR-U, reset if at least one HARQ-ACK feedback is ACK for PDSCH(s) with transport block based feedback or at least 10% of HARQ-ACK feedbacks is ACK for PDSCH code clock group (CBGs) transmitted at least partially on the channel with code block group based feedback. Otherwise, the CW is doubled to the next feasible value with CWmax as the maximum possible value.

On the UL, the CW is reset to CWmin for LAA LTE if the New Data Indicator (NDI) bit is toggled in a UL scheduling Downlink Control Information (DCI) or autonomous UL downlink feedback indication (AUL-DFI) indicates an ACK for PUSCH. For NR-U UL, reset if at least one implicit or explicit HARQ-ACK feedback is ACK for PUSCH(s) with transport block (TB) based feedback or at least 10% of HARQ-ACK feedbacks are ACK for PUSCH CBGs transmitted at least partially on the channel with code block group (CBG) based feedback. Otherwise, the CW is doubled to the next feasible value with CWmax as the maximum possible value.

After initiating a channel occupancy (CO), with regard to a DL channel or UL channel, with random backoff listen-before-talk (LBT), the gNB or UE can share the CO with another device that accesses the channel either without performing any LBT or performs a fixed-duration LBT.

In Rel-18, the extension of NR sidelink (SL) operation to unlicensed spectrum (SL-U) in 5 GHz and 6 G Hz will be studied. SL has multiple peer-to-peer communication modes between two or more UEs, unlike DL and UL communication modes between a base station and a UE.

SL was introduced in Rel-16 for vehicle-to-everything (V2X) scenarios and enhanced further in Rel-17. SL supports unicast, multicast (groupcast), and broadcast modes. A separate set of NR reference and physical channels have been introduced for SL operation (See M. Harounabadi, D. M. Soleymani, S. Bhadauria, M. Leyh and E. Roth-Mandutz, I V2X in 3GPP Standardization: NR Sidelink in Release-16 and Beyond, IEEE Communications Standards Magazine, vol. 5, no. 1, pp. 12-21, March 2021, doi: 10.1109/MCOMSTD.001.2000070) which is hereby expressly incorporated by reference). The set of NR reference and physical channels for SL operation include a Physical Sidelink Broadcast Channel (PSBCH), a Physical Sidelink Feedback Channel (PSFCH), a Physical Sidelink Shared Channel (PSSCH) and a Physical Sidelink Control Channel (PSCCH).

Physical Sidelink Broadcast Channel (PSBCH) is for the SL-BCH transport channel where the Master Information Block (MIB) for SL is sent periodically (each 160 ms) and comprises system information for UE to UE communication (e.g., SL TDD configuration, in-coverage flag). PSBCH is transmitted along with the Sidelink Primary Synchronization Signal/Sidelink Secondary Synchronization Signal (S-PSS/SSS) in the S-SSB (see synchronization signals).

Physical Sidelink Feedback Channel (PSFCH) is for HARQ feedback from a receiver UE to the transmitter UE on the SL for a unicast or groupcast communication. There is no HARQ feedback for broadcast mode.

Physical Sidelink Shared Channel (PSSCH) is for user plane data, and Physical Sidelink Control Channel (PSCCH) is for scheduling and resource allocation.

Resource pools are defined for SL, where a resource pool limits the radio resources used for PSCCH and PSSCH since they cannot be transmitted in all Resource Blocks (RBs) and slots of NR.

Two modes of resource allocation are specified in NR-SL Mode 1: resources are allocated by a gNB for in-coverage user equipments (UEs); Mode 2: autonomous resource selection by a user equipment (UE) based on a sensing procedure when out-of-coverage for gNBs. In Mode 1, a UE can send PSSCH acknowledgment/negative acknowledgment (ACK/NACK) feedback on the UL to the gNB (See TS 38.212 V16.6.0 (2021-06) NR; Multiplexing and channel coding (Release 16) which is hereby expressly incorporated by reference).

In Mode 2 resource selection by a UE, the sensing takes place in a pre-configured resource pool. UEs can select resources for transmission and re-transmission if the resources are not in use by other UEs with higher priority traffic. A UE, which performs sensing, measures the sidelink reference signal received power (SL-RSRP) of either PSCCH or PSSCH (See M. Harounabadi, D. M. Soleymani, S. Bhadauria, M. Leyh and E. Roth-Mandutz, I V2X in 3GPP Standardization: NR Sidelink in Release-16 and Beyond, IEEE Communications Standards Magazine, vol. 5, no. 1, pp. 12-21, March 2021, doi: 10.1109/MCOMSTD.001.2000070).

The UE considers its recent sensing results between 1100 ms and 100 ms prior to the trigger time for resource selection (e.g., due to transport block arrival). The 1100 ms sensing window is beneficial to identify the reserved resources by other UEs for periodic traffic, which are sent in the 1st stage sidelink control information (SCI) on PSCCH (See TS 38.212 V16.6.0 (2021-06) NR; Multiplexing and channel coding (Release 16)).

The UE excludes the resources where the measured RSRP is higher than a threshold and considers them as occupied if the traffic priority in the measured resources is higher than its traffic priority. Otherwise, the UE may select the occupied resource if it has higher priority traffic.

The extension of NR SL operation to unlicensed spectrum in 5 GHz and 6 GHz in Rel-18 requires that the channel access or listen-before-talk (LBT) mechanisms of SL-U and NR-U/WiFi be aligned for fair coexistence in the same spectrum.

Based on the above discussion there is a need for new methods and apparatus for efficient channel access procedures for sidelink (SL) communications using unlicensed spectrum. It would be advantageous if at least some of these new methods and apparatus provided for individual communications device access parameter adjustment determinations, e.g., contention window value adjustments, based on locally detected sidelink channel conditions, with the sidelink channel evaluation method being used being matched to the sidelink transmission mode.

### SUMMARY

Various methods and apparatus are directed to new sidelink-unlicensed (SL-U) channel access mechanisms that are aligned with existing New Radio-Unlicensed (NR-U) Listen-Before-Talk (LBT) methods that were established in Rel-16.

A communications device determines a contention window value, e.g., an adjusted contention window value, to be used by the communications device in upcoming sidelink access operations for unlicensed spectrum, e.g., in LBT channel sensing operations, prior to being allowed to transmit sidelink signals, e.g., PSCCH and PSSCH channel signals, in unlicensed spectrum. When the communications device is operating in a unicast or groupcast transmit mode with regard to sidelink traffic signals, the communications device implements a HARQ response based contention window update process. When the communications device is operating in a broadcast transmit mode with regard to sidelink signals, the communications device implements a SL-RSRP evaluation based contention window update process.

An exemplary method of operating a communications device, in accordance with some embodiments, comprises: transmitting physical sidelink shared channel signals; monitoring for HARQ responses to one or more of the transmitted physical sidelink shared channel signals; determining if a HARQ response corresponding to one or more of the physical sidelink shared channel signals was received in a reference duration time period; and determining a contention window size to use in a channel sensing operation based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

An exemplary method of operating a communications device, in accordance with some embodiments, comprises: measuring sidelink-reference signal received power (SL-RSRP) during a sensing duration; examining measured SL-RSRP to determine if the measured SL-RSRP during the sensing duration was above a predetermined threshold for more than a predetermined portion of the sensing duration; and performing a contention window size update operation including: i) setting a current contention window size being used to a minimum contention window size in response to determining that the measured SL-RSRP was not above a predetermined threshold for more than a predetermined portion of the sensing duration; and ii) increasing or maintaining the current contention window size in response to determining that the measured SL-RSRP was above the predetermined threshold for more than a predetermined portion of the sensing duration.

Numerous variations on the described methods and apparatus are possible and while several embodiments are described in detail it should be appreciated that the full set of detailed steps need not be used in all embodiments with many of the features and determinations being useful even if not used with the other features and steps.

The detailed description which follows describes additional features, details and embodiments which can be used alone or in combination.

### BRIEF DESCRIPTION OF THE FIGURES

FIG. 1 is a drawing of an exemplary communications system in accordance with an exemplary embodiment.

FIG. 2 is a drawing illustrating an exemplary recurring frequency/timing structure for sidelink communications including exemplary air link resources, exemplary channels and exemplary sensing intervals and further illustrating a reference duration and a time at which a contention window adjustment is performed in accordance with an exemplary embodiment.

FIG. 3A is a first part of a flowchart of an exemplary method of operating a communications device, e.g., a user equipment (UE) supporting sidelink communications in unlicensed spectrum, in accordance with an exemplary embodiment.

FIG. 3B is a second part of a flowchart of an exemplary method of operating a communications device, e.g., a user equipment (UE) supporting sidelink communications in unlicensed spectrum, in accordance with an exemplary embodiment.

FIG. 3C is a third part of a flowchart of an exemplary method of operating a communications device, e.g., a user equipment (UE) supporting sidelink communications in unlicensed spectrum, in accordance with an exemplary embodiment.

FIG. 3 comprises the combination of FIG. 3A, FIG. 3B and FIG. 3C.

FIG. 4 is a drawing of an exemplary communications device, e.g., a user equipment (UE) supporting sidelink communications in unlicensed spectrum, in accordance with an exemplary embodiment.

FIG. 5A is a first part of an exemplary assembly of components, which may be included in a communications device in accordance with an exemplary embodiment.

FIG. 5B is a second part of an exemplary assembly of components, which may be included in a communications device in accordance with an exemplary embodiment.

FIG. 5C is a third part of an exemplary assembly of components, which may be included in a communications device in accordance with an exemplary embodiment.

FIG. 5 comprises the combination of FIG. 5A, FIG. 5B and FIG. 5C.

### DETAILED DESCRIPTION

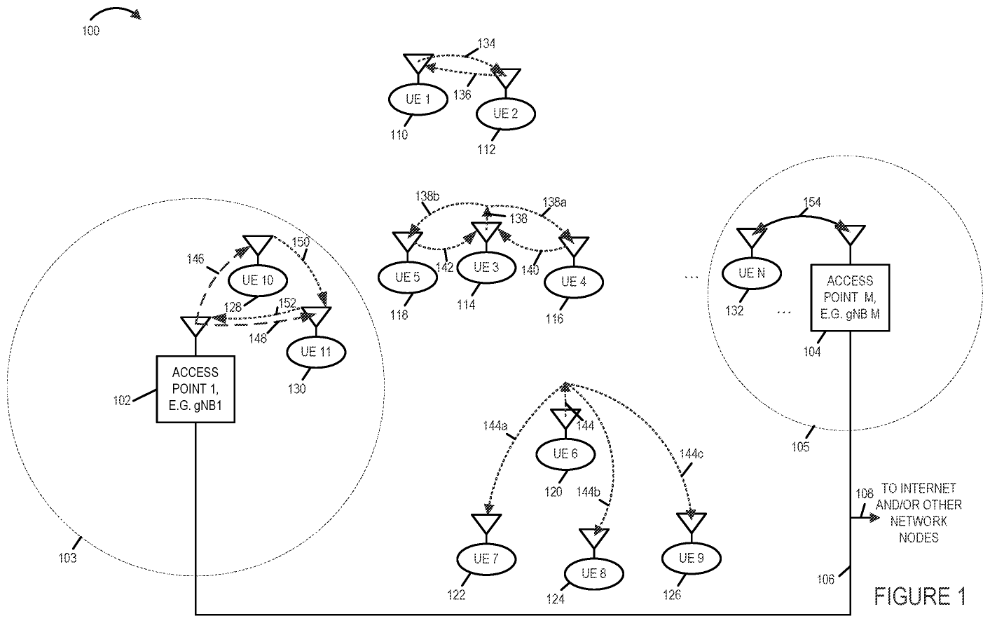

FIG. 1 is a drawing of an exemplary communications system 100 in accordance with an exemplary embodiment. Exemplary communications system 100 includes a plurality of access points (access point 1 102, e.g., gNB 1, access point M, e.g., gNB M 104), each with a corresponding wireless coverage area (access point 1 coverage area 103, access point M coverage area 105), respectively. The access points (102, 104) are coupled together via backhaul network 106, and/or coupled to the Internet and/or other network nodes via connection 108. Exemplary communications system 100 further includes a plurality of user equipments (UE 1 110, UE 2 112, UE 3 114, UE 4 116, UE 5 118, UE6 120, UE 7 122, UE 8 124, UE 9 126, UE 10 128, UE 11 130, UE N 132), which support sidelink communications in unlicensed spectrum, and are implemented in accordance with the present invention, e.g., support contention window size selection and adjustment for sidelink unlicensed communications using methods in accordance with the present invention.

Consider that UEs (UE 1 110, UE 2 112, UE 3 114, UE 5 118, UE 6 120, UE 7 122, UE 8 124 and UE 9 126), which are out-of-coverage with regard to the gNBs (102, 104) are using a NR SL-mode 2 resource selection (autonomous resource selection). Further consider that UEs (UE 10 128, UE 11 130 and UE N 132), which are located within the coverage area (103, 103, 105) of a gNB (102, 102, 104), respectively, use a NR SL-mode 1 resource selection (resources allocated by gNB).

Arrow 134 represents sidelink signals including PSCCH and PSSCH signals being transmitted on unlicensed spectrum by UE 1 110 to UE 2 112. Arrow 136 represents Ack/Nack signals, in response to PSSCH signals, the ack/nack signals being transmitted on unlicensed spectrum by UE 2 112 to UE 1 110. UE 1 110, which is operating in unicast mode with regard to the transmission of sidelink PSSCH and PSCCH signals in unlicensed spectrum, determines a contention window value to be used based on received feedback from UE 2 112, e.g., received ack/nack signals or the lack thereof.

Arrow 138 represents sidelink signals including PSCCH and PSSCH signals being transmitted on unlicensed spectrum by UE 3 114, as groupcast signals to UE 5 118 and UE 4 116. Arrow 138a represents signal 138 as received by UE 4 116. Arrow 138b represents signal 138 as received by UE 5 118. Arrow 140 represents Ack/Nack signals, in response to PSSCH signals in received signals 138a, the ack/nack signals being transmitted on unlicensed spectrum by UE 4 116 to UE 3 114. Arrow 142 represents Ack/Nack signals, in response to PSSCH signals in received signals 138b, the ack/nack signals being transmitted on unlicensed spectrum by UE 5 118 to UE 3 114. UE 3 114, which is operating in groupcast mode with regard to the transmission of sidelink PSSCH and PSCCH signals in unlicensed spectrum, determines a contention window value to be used based on received feedback from UE 4 116 and UE 5 118, e.g., received ack/nack signals or the lack thereof.

Arrow 144 represents sidelink signals including PSCCH signals and PSBCH or PSSCH signals being transmitted on unlicensed spectrum by UE 6 120, as broadcast signals. Arrow 144a represents signal 144 as received by UE 7 122. Arrow 144b represents signal 144 as received by UE 8 124. Arrow 144c represents signal 144 as received by UE 9 120. UE 6 120, which is operating in broadcast mode with regard to the transmission of sidelink PSCCH signals and PSBCH or PSCCH signals in unlicensed spectrum, determines a contention window value to be used based on evaluation of SL-RSRP measured during a sensing duration.

Arrow 146 represents control signals, e.g., resource allocation control signals for sidelink communications in unlicensed spectrum, being sent from gNB 1 102 to UE 10 128. Arrow 148 represents control signals, e.g., resource allocation control signals for sidelink communications in unlicensed spectrum, being sent from gNB 1 102 to UE 11 130. Arrow 150 represents unicast sidelink signals including PSCCH and PSSCH signals being sent in unlicensed spectrum by UE 10 128 to UE 11 130. Arrow 152 represents ack/nack feedback signals, in response to the PSSCH signals included in signals 150 from UE 10 128, being sent by UE 11 130 to gNB1 102 via PUSCH. UE 10 114 is operating in unicast mode with regard to the transmission of sidelink PSSCH and PSCCH signals in unlicensed spectrum; therefore, a contention window value to be used is based on received feedback from UE 11 130, e.g., received ack/nack signals (communicated in PUSCH to gNB 1 102) or the lack thereof.

Bi-directional arrow 154 represents wireless communications signaling between gNB M 104 and UE N 132, which may, and sometimes does, include communications in an unlicensed spectrum.

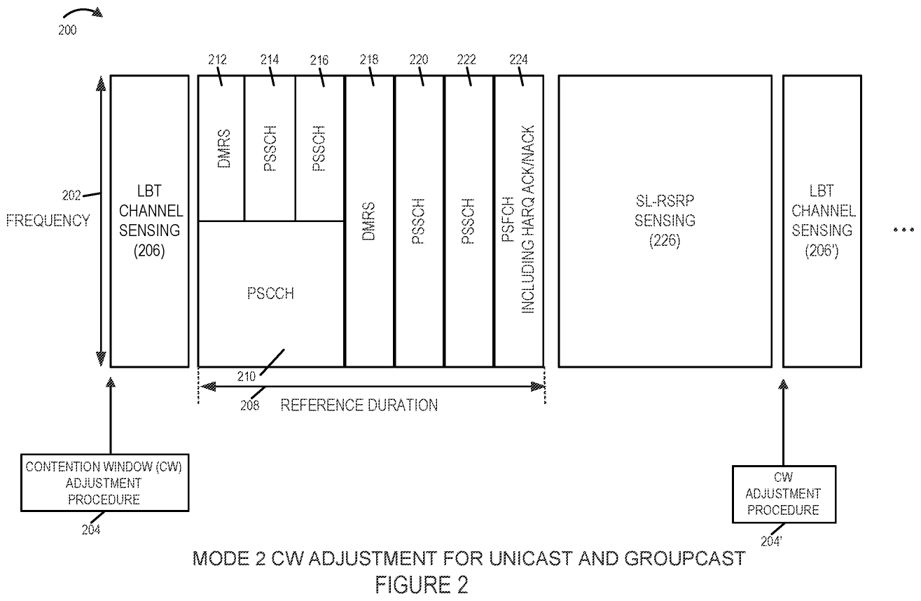

FIG. 2 is a drawing 200 illustrating an exemplary recurring frequency/timing structure for sidelink communications including exemplary air link resources, exemplary channels and exemplary sensing intervals and further illustrating a reference duration and a time at which a contention window (CW) adjustment is performed in accordance with an exemplary embodiment. FIG. 2 illustrates an exemplary structure for resource allocation Mode 2 (autonomous resource selection by a UE) CW adjustment for unicast and groupcast. Vertical axis 202 represents frequency, while the horizontal is used to represent time.

The exemplary recurring structure includes listen-before-talk (LBT) channel sensing time-frequency resources 206, followed by a reference duration 208. During the reference duration 208 there are a set of channels including: physical sidelink control channel (PSCCH) 210, demodulation reference signal (DMRS) channel 212, physical sidelink shared channel (PSSCH) 214, PSSCH 216, DMRS 218, PSSCH 220, PSSCH 222, DMRS 218, and physical sidelink feedback channel (PSFCH) 224. The PSFCH 224 is used to convey Hybrid Automatic Acknowledgments/Negative Acknowledgments (HARQ ACK/NACKS), corresponding to previously transmitted PSSCH signals. Following the reference duration 208 and prior to the next LBT channel sensing block 206 there is a block of time-frequency sidelink reference signal received power (SL-RSRP) sensing resources 226.

Prior to the LBT channel sensing block 206, a contention window (CW) adjustment procedure 204 is performed to set, e.g., adjust, a contention window value. The contention window value, generated in procedure 204, is used by the communications device in the LBT channel sensing operations of block 206.

Subsequent to SL-RSRP sensing block 226, LBT channel sensing block (206 occurs. Prior to the LBT channel sensing block 206, CW adjustment procedure 204 is performed.

In a case where the communications device is operating in unicast or groupcast mode (with regard to sidelink transmissions and intends to transmit unicast or groupcast signals in an upcoming PSSCH), the communications device determines a CW value as a function of detected ack/nack information or lack thereof of detected ack/nack signals in the prior PSFCH. Thus, in such a scenario the CW value determined by adjustment 204, which is to be used for LBT sensing of block 206, is a function of ack/nack information in a PSFCH or lack thereof of ack/nack in PSFCH.

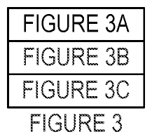

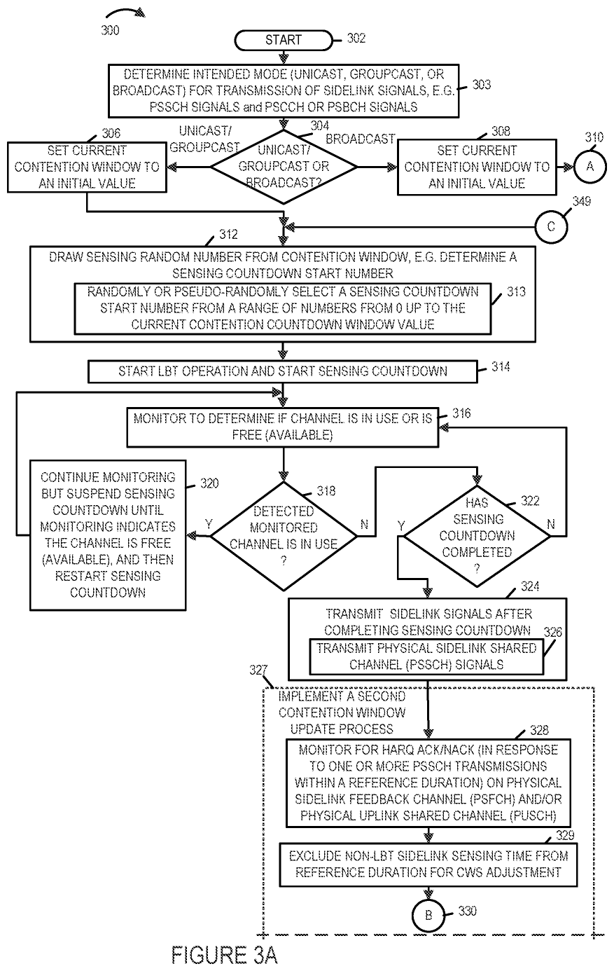

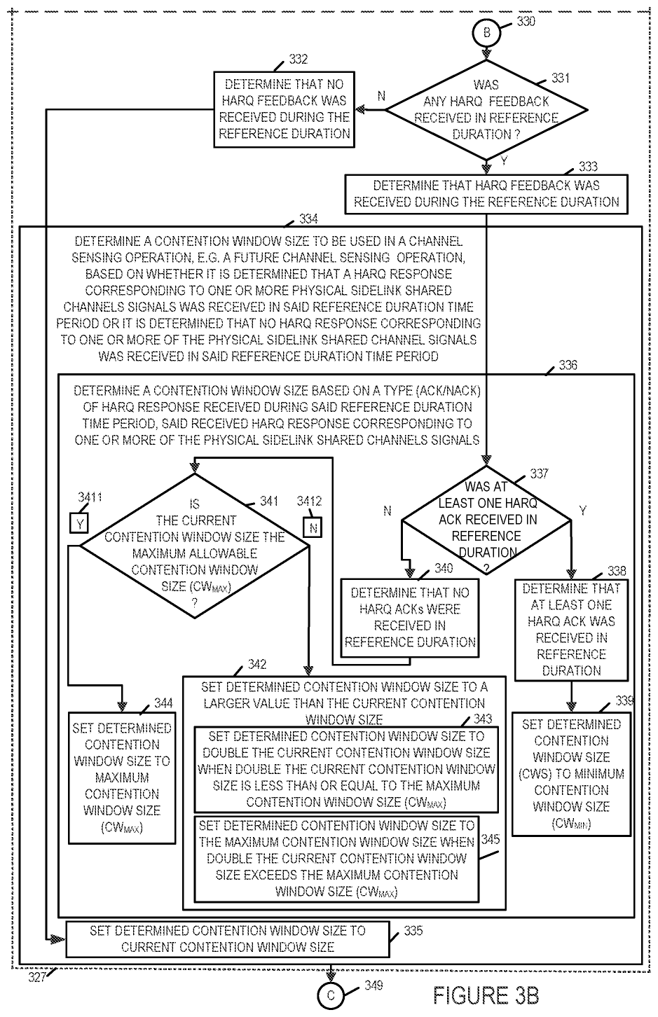

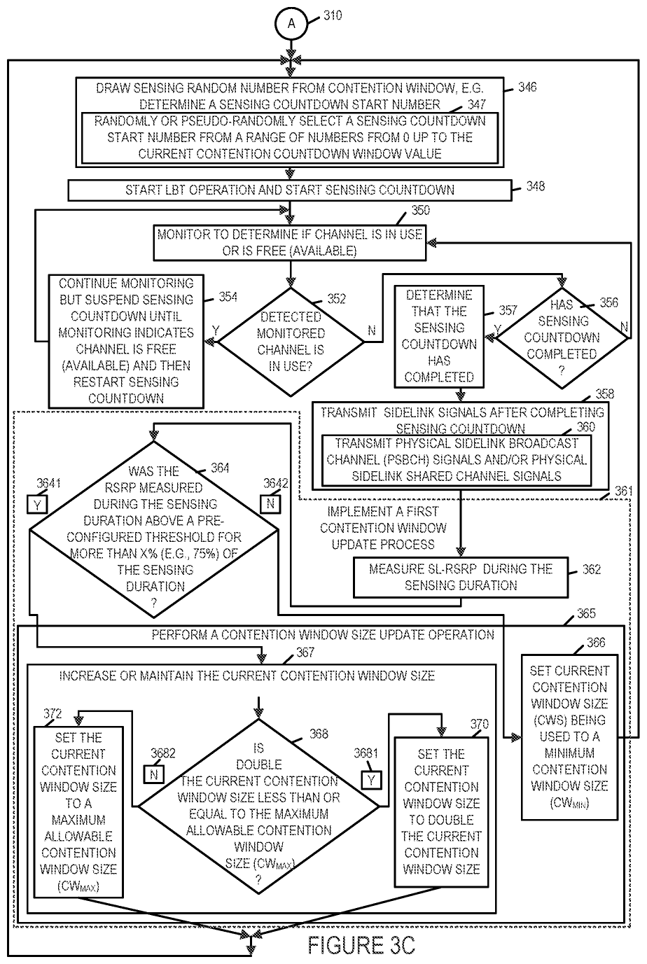

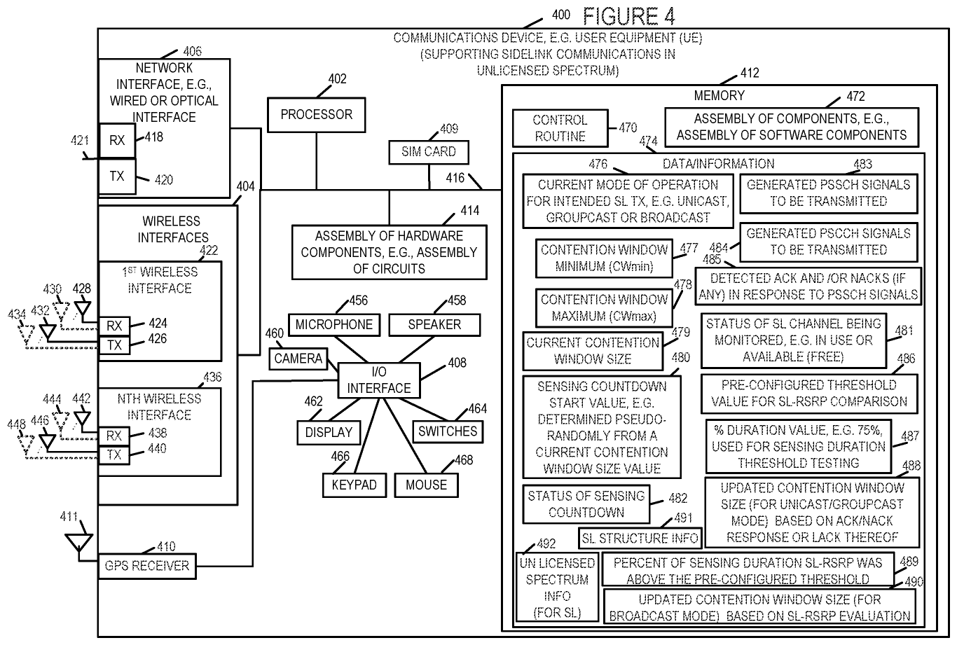

FIG. 3, comprising the combination of FIG. 3A, FIG. 3B and FIG. 3C, is a flowchart 300 of an exemplary method of operating a communications device, e.g., a first user equipment (UE) device supporting sidelink communications in unlicensed spectrum, in accordance with an exemplary embodiment. The communications device implementing the method of flowchart 300 of FIG. 3 is, e.g., any of the UE s (UE 1 110, UE 2 112, UE 3 114, UE 4 116, UE 5 118, UE 6 120, UE 7 122, UE 8 124, UE 9 126, UE 10 128, UE 11 130 UE N 132) of system 100 of FIG. 1, and/or communications device 400 of FIG. 4.

Operation starts in step 302 in which the communications device is powered on and initialized. Operation proceeds from start step 302 to step 303. In step 303 the communications device determines an intended mode (unicast, groupcast or broadcast) for transmission of sidelink signals, e.g., physical sidelink shared channel (PSSCH) and physical sidelink control channel (PSCCH) signals/physical sidelink broadcast channel (PSBCH) signals. Operation proceeds from step 303 to step 304. In step 304, if the intended mode for transmission is unicast or groupcast, then operation proceeds from step 304 to step 306. However, if the intended mode for transmission is broadcast mode, then operation proceeds from step 304 to step 308.

In step 306 the communications device sets the current contention window to initial value, e.g., an initial value for unicast/groupcast mode. In some embodiments, the initial value is CWmin. Operation proceeds from step 306 to step 312. In step 312 the communications device draws a sensing random number from the contention window, e.g., the communications device determines a sensing countdown start number using a random number generator, said generated sensing countdown start number being less than or equal to the current contention window value. In some embodiments, step 312 includes step 313, in which the communications device randomly or pseudo-randomly selects a sensing countdown start number from a range of numbers from 0 up to the current contention countdown window value. Operation proceeds from step 312 to step 314. In step 314 the communications device starts a listen-before-talk (LBT) operation and starts the sensing countdown using the selected countdown start number. Operation proceeds from step 314 to step 316.

In step 316 the communications device monitors to determine if the channel (intended to be used for transmitting sidelink signals, e.g., PSSCH and PSCCH signals) is in use or is free (available). Operation proceeds from step 316 to step 318. In step 318 the communications device determines if it has been detected, based on the monitoring and predetermined threshold criteria, that the monitored channel is in use or is free. If the determination is that the channel is in use, then operation proceeds from step 318 to step 320. In step 320 the communications device continues monitoring but suspends the sensing countdown, until the monitoring indicates that the channel is free (available), and then the communications device restarts the sensing countdown. Operation proceeds from step 320 to the input of step 316 for additional monitoring while the sensing countdown is proceeding.

Returning to step 318, in step 318, if the determination is that the channel is not in use (e.g., the channel is free), then operation proceeds from step 318 to step 322. In step 322 the communications device determines if the sensing countdown has completed, e.g., the communications device determines if the countdown has reached 0. If the determination is that the sensing countdown has not completed, then operation proceeds from step 322 to the input of step 316 for additional monitoring while the sensing countdown is proceeding. However, if the determination is that the sensing countdown has completed, then operation proceeds from step 322 to step 324.

In step 324 the communication device transmits sidelink signals, e.g., PSSCH signals and PSCCH signals, after completing the sensing countdown. Step 324 includes step 326, in which the communications device transmits physical sidelink shared channel (PSSCH) signals. Operation proceeds from step 324 to step 328.

In step 328 the communications device monitors for Hybrid Automatic Repeat Request (HARQ) acknowledgment/negative acknowledgement (ACK/NACK), in response to one or more PSSCH transmissions within a reference duration, on physical sidelink feedback channel (PSFCH) and/or on physical uplink shared channel (PUSCH). Operation proceeds from step 328 to step 329. In step 329 the communications device excludes non-LBT sidelink sensing time from reference duration (e.g., the SL-RSRP sensing duration of block 226) with regards to making a contention window size (CWS) adjustment. Thus, in various embodiments, the communications device does not consider measured sidelink reference signal received power (SL-RSRP) measurements obtained during the SL-RSRP sensing duration, which follows the PSFCH duration during which ACK/NACK may be detected, when making a CWS adjustment while the intended mode for transmission is unicast or groupcast.

Operation proceeds from step 329, via connecting node B 330 to step 331. In step 331 the communications device determines if any HARQ feedback was received in the reference duration. If the communications device determines that no HARQ feedback was received in the reference duration, as indicated by block 332, then operation proceeds from step 331 (via block 332) to step 335 in which the communications device sets the determined contention window size to the current contention window size, e.g., the current contention window size remains unchanged.

However, if the communications device determines that HARQ feedback was received during the reference duration, as indicated by block 333, then operation proceeds from step 331 (via block 333) to step 337. In step 337 the communications device determines if at least one HARK ACK was received in the reference duration. If the communications device determines that at least one ACK was received in the reference duration, as indicated by block 338, then operation proceeds from step 337 (via block 338) to step 339, in which the communications device sets the determined contention window size (CWS) to a minimum contention window size (CWmin). Alternatively, if the communications device determines that there was not at least one HARQ ACK received in the reference duration, as indicated by block 340, then operation proceeds from step 337 (via block 340) to step 341.

In step 341 the communications device determines if the current contention window size is the maximum allowable contention window size. If the determination is that the current contention window size is the maximum allowable contention window size, as indicated by Y block 3411, then operation proceeds from step 341 to step 344, in which the communications device sets the determined contention window size to a maximum contention window size (CWmax). Alternatively, if the determination is that the current contention window size is not the maximum allowable contention window size, as indicated by N block 3412, then operation proceeds from step 341 to step 342. In step 342 the communications device sets the determined contention window size to a larger value than the current contention window size. Step 342 includes step 343 and 345, one of which is implemented for each iteration of step 342. In step 343 the communications device sets the determined contention window size to double the current contention window size when double the contention window size is less than or equal to the maximum contention window size (CWmax). In step 345, the communications device sets the determined contention window size to the maximum contention window size when double the current contention window size exceeds the maximum contention window size (CWmax).

Step 336 is a grouping of steps 337, 338, 339, 340, 341, 342, 343, 345 and 344. In step 336 the communications device determines a contention window size based on a type (ACK/NACK) of HARQ response received during said reference duration time period, said received HARQ response corresponding to one or more or the physical sidelink shared channel signals.

Step 334 is a grouping of steps 335 and step 336 including steps 337, 338, 339, 340, 341, 342, 343, 345 and 344. In step 334, the communications device determines a contention window size to be used in a channel sensing operation, e.g., a future channel sensing operation, based on whether it is determined that a HARQ response corresponding to one or more physical sidelink shared channel signals was received in said reference duration time period or it is determined that no HARQ response corresponding to one or more of the physical sidelink shared channel signals was received in the reference duration time period.

Operation proceeds from step 334, via connecting node C 349, to the input of step 312. In steps 312 and 313, the determined contention window size (obtained from one of steps 335, 344, 343, 345 or 339) is used as the current contention window size (an updated current contention window size).

Step 327 includes the combination of steps 328, 329, 331, 332, 333, 334, 335, 336, 337, 338, 339, 340, 341, 343, 343, 344 and 345. In step 327 the communications device implements a second contention window update process, e.g., the communications device implements a contention window update process for operation in unicast or groupcast transmit mode with regard to sidelink transmission in unlicensed spectrum, in which the second contention window update process performs an update to a current contention window value based on feedback response information, e.g., HARQ ACK/NACKs, received in PSFCH, and/or a lack of detected responses, in response to previously transmitted PSSCH signals.

Returning to step 308, in step 308 the communications device sets the current contention window to initial value, e.g., an initial value for broadcast mode. In some embodiments, the initial value is CWmin. Operation proceeds from step 308, via connecting node A 310 to step 346 of FIG. 3C. In step 346 the communications device draws a sensing random number from the contention window, e.g., the communications device determines a sensing countdown start number using a random number generator, said generated sensing countdown start number being less than or equal to the current contention window value. In some embodiments, step 346 includes step 347, in which the communications device randomly or pseudo-randomly selects a sensing countdown start number from a range of numbers from 0 up to the current contention countdown window value. Operation proceeds from step 346 to step 348. In step 348 the communications device starts a listen-before-talk (LBT) operation and starts the sensing countdown using the selected countdown start number. Operation proceeds from step 348 to step 350.

In step 350 the communications device monitors to determine if the channel (intended to be used for transmitting sidelink signals, e.g., PSCCH signals and PSBCH or PSSCH signals) is in use or is free (available). Operation proceeds from step 350 to step 352. In step 352 the communications device determines if it has been detected, based on the monitoring and predetermined threshold criteria, that the monitored channel is in use or is free. If the determination is that the channel is in use, then operation proceeds from step 352 to step 354. In step 354 the communications device continues monitoring but suspends the sensing countdown, until the monitoring indicates that the channel is free (available), and then the communications device restarts the sensing countdown. Operation proceeds from step 354 to the input of step 350 for additional monitoring while the sensing countdown is proceeding.

Returning to step 352, in step 352, if the determination is that the channel is not in use (e.g., the channel is free), then operation proceeds from step 352 to step 356. In step 356 the communications device determines if the sensing countdown has completed, e.g., the communications device determines if the countdown has reached 0. If the determination is that the sensing countdown has not completed, then operation proceeds from step 356 to the input of step 350 for additional monitoring while the sensing countdown is proceeding. However, if the determination is that the sensing countdown has completed, as indicated by block 357, then operation proceeds from step 356 (via block 357) to step 358.

In step 358 the communication device transmits sidelink signals, (e.g., PSBCH signals or PSSCH signals, and PSCCH signals), after completing the sensing countdown. Step 358 includes step 360, in which the communications device transmits (broadcasts) physical sidelink broadcast (PSBCH) signals and/or physical sidelink shared channel (PSSCH) signals. Operation proceeds from step 358 to step 361.

In step 361 the communications device implements a first contention window update process, e.g., the communications device implements a contention window update process for operation in broadcast transmit mode with regard to sidelink transmission in unlicensed spectrum, in which the first contention window update process performs an update to a current contention window value, based evaluation results of measured SL-RSRP during a SL-RSRP sensing duration. Step 361 includes steps 362, 364, 365, 366, 367, 368, 370 and 372.

In step 362 the communications device measures sidelink reference signal received power (SL-RSRP) during a SL-RSRP sensing duration (e.g., block 226 of FIG. 2). Operation proceeds from step 362 to step 364. In step 364, the communications device determines if the RSRP measured during the sensing duration was above a pre-configured threshold for more than X % (e.g., 75%) of the sensing duration.

Operation proceeds from step 364 to step 365, in which the communications device performs a contention window size update operation. Step 365 includes steps 366, 367, 368, 370 and 372.

If the determination of step 364 is that the RSRP measured during the sensing duration was not above a pre-configured threshold for more than X % (e.g., 75%) of the sensing duration, as indicated by N 3642, then operation proceeds from step 364 to step 366. In step 366 the communications device sets the current contention window size (CWS) being used to a minimum contention window size (CWmin).

Alternatively, if the determination of step 364 is that the RSRP measured during the sensing duration was above a pre-configured threshold for more than X % (e.g., 75%) of the sensing duration, as indicated by Y 3641, then operation proceeds from step 364 to step 367. In step 367 the communications device increases or maintains the current contention window size. Step 367 includes steps 368, 370 and 372. In step 368 the communications device determines if double the current contention window size is less than or equal to the maximum allowable contention window size (CWmax). If the determination of step 368 is that the double the current contention window size is less than or equal to the maximum allowable contention window size, as indicated by Y 3681, then operation proceeds from step 368 to step 370, in which the communications device sets the current contention window size to double the current contention window size, e.g., the value of the variable current contention window size is doubled. However, if the determination of step 368 is that the double the current contention window size is not less than or equal to the maximum allowable contention window size, as indicated by N 3682, then operation proceeds from step 368 to step 372, in which the communications device sets the current contention window size to the maximum allowable contention window size (CWmax).

Operation proceeds from one of steps 366, 370 or 372, to the input of step 346. In steps 346 and 347, the determined updated current contention window size (obtained from one of steps 366, 370 or 372) is used as input in determining a new sensing countdown start number for the LBT operation.

FIG. 4 is a drawing of an exemplary communications device 400, e.g., a user equipment (UE) supporting sidelink communications in unlicensed spectrum, in accordance with an exemplary embodiment. Exemplary communications device 400 is, e.g., any of the UE s (UE 1 110, UE 2 112, UE 3 114, UE 4 116, UE 5 118, UE 6 120, UE 7 122, UE 8 124, UE 9 126, UE 10 128, UE 11 130 UE N 132) of system 100 of FIG. 1 and/or a communications device, e.g., a UE, implementing the method of flowchart 300 of FIG. 3.

Exemplary communications device 400 includes a processor 402, e.g., a CPU, wireless interfaces 404, a network interface 406, an I/O interface 408, a SIM card 409, a GPS receiver 410, memory 412, and an assembly of hardware components 414, e.g., an assembly of circuits, coupled together via a bus 416 over which the various elements may interchange data and information. Communications device 400 further includes a plurality of I/O devices (microphone 456, speaker 458, camera 460, display 462, e.g., a touchscreen display, switches 464, keypad 466 and mouse 468) coupled to I/O interface 408, via which the various I/O devices may communicate with other elements of communications device 400.

Wireless interfaces 404 includes a plurality of wireless interfaces (1st wireless interface 422, Nth wireless interface 436). 1st wireless interface 422 includes a wireless receiver 424 and a wireless transmitter 426. Wireless receiver 424 is coupled to one or more receive antennas or antenna elements (428, 430) via which the communications device 400 may receive wireless signals, e.g., wireless signals including sidelink wireless signals in unlicensed spectrum, from other wireless communications devices. Wireless transmitter 426 is coupled to one or more transmit antennas or antenna elements (432, 434) via which the communications device 400 may transmit wireless signals, e.g., wireless signals including sidelink wireless signals in unlicensed spectrum, to other wireless communications devices. In some embodiments, the same antennas or antenna elements may be, and sometimes are, used for receive and transmit.

Nth wireless interface 436 includes a wireless receiver 438 and a wireless transmitter 440. Wireless receiver 438 is coupled to one or more receive antennas or antenna elements (442, 444) via which the communications device 400 may receive wireless signals, e.g., wireless signals including sidelink wireless signals in unlicensed spectrum, from other wireless communications devices. Wireless transmitter 440 is coupled to one or more transmit antennas or antenna elements (446, 448) via which the communications device 400 may transmit wireless signals, e.g., wireless signals including sidelink wireless signals in unlicensed spectrum, to other wireless communications devices. In some embodiments, the same antennas or antenna elements may be, and sometimes are, used for receive and transmit. In some embodiments, 1st wireless interface 422 supports different frequencies than is supported by Nth wireless interface 436, e.g., the 1st wireless interface 422 supports communications in spectrum including 5G Hz unlicensed spectrum and the Nth wireless interface 436 supports communications in spectrum including 6 GHz unlicensed spectrum.

Network interface 406, e.g., a wired or optical interface, includes a receiver 418 and a transmitter 420. The receiver 418 and transmitter 420 are coupled to a wireline or optical connector 421, via which the communications device 400 may be coupled to a wireline connection or optical connection when available.

GPS receiver 410 is coupled to GPS antenna 411, via which the communications device receives GPS signals from GPS satellites. The received GPS signals are processed by the GPS receiver 410 to determine time, position, e.g., latitude/longitude, altitude, velocity information, and acceleration information.

Memory 412 includes a control routine 470, an assembly of components 472, e.g., an assembly of software components, and data/information 474. Control routine 470, when implemented by processor 402, controls communications device 400 to implement basic functions such as, e.g., memory access, memory storage, I/O device control, interface control, etc. Assembly of software components 472 includes, e.g., software routines, software subroutines, software modules, applications, etc., which when executed by processor 402 control the communications device 400 to implement steps of an exemplary method, e.g., steps of the exemplary method of flowchart 300 of FIG. 3.

Data/information 474 includes a current mode of operation 476, for intended sidelink (SL) transmission (TX), e.g., unicast mode, groupcast mode, or broadcast mode, a contention window minimum allowable size (CWmin) 477, a contention window maximum allowable size (CWmax) 478, a current contention window size 479, a sensing countdown start value 480, e.g., a countdown start value determined randomly or pseudo-randomly from a current contention window size value, a status of the sensing countdown 480, e.g., in progress, suspended, or completed, with a sensing countdown current value, status of SL channel being monitored 481, e.g. in use or available (free), generated PSSCH signals to be transmitted 483, generated PSCCH signals to be transmitted 484, detected ACK and/or NACK signals (if any) in response to previously transmitted PSSCH signals 485, a pre-configured threshold value for SL-RSRP comparison 486, a % duration value, e.g. 75%, used for sensing duration threshold testing 487, an updated contention window size (for unicast mode/groupcast mode) based on ack/nack response or lack thereof 488, a determined percentage of the SL-RSRP sensing duration during which the measured SL-RSRP was above the pre-configured threshold value 489, an updated contention window size (for broadcast mode) based on the SL-RSRP evaluation 490 and unlicensed spectrum information (for SL) 492, e.g. information identifying a frequency band to be used for sidelink communications and SL structure information, e.g. information identifying various sidelink channels.

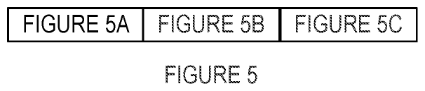

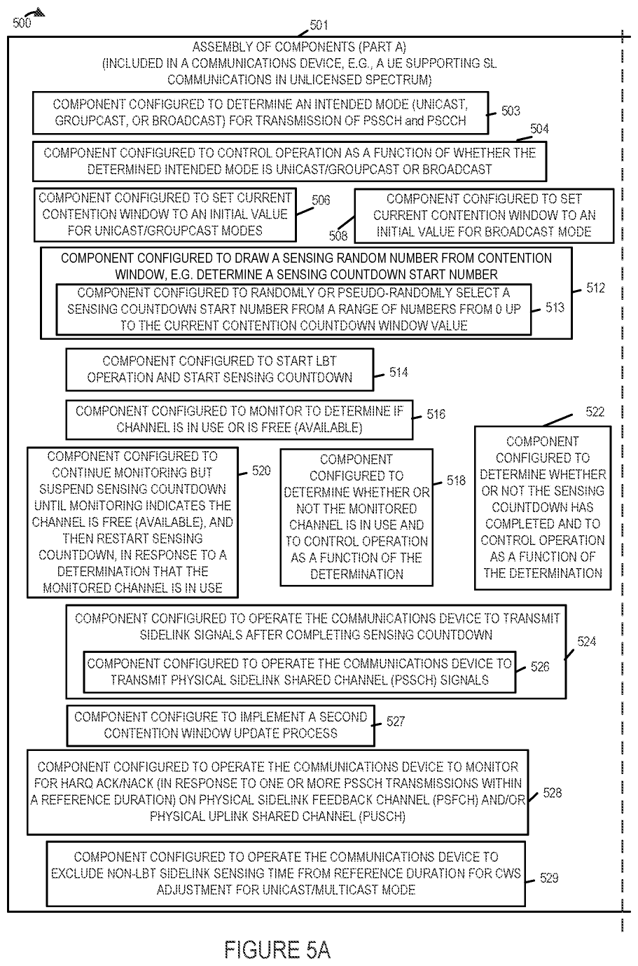

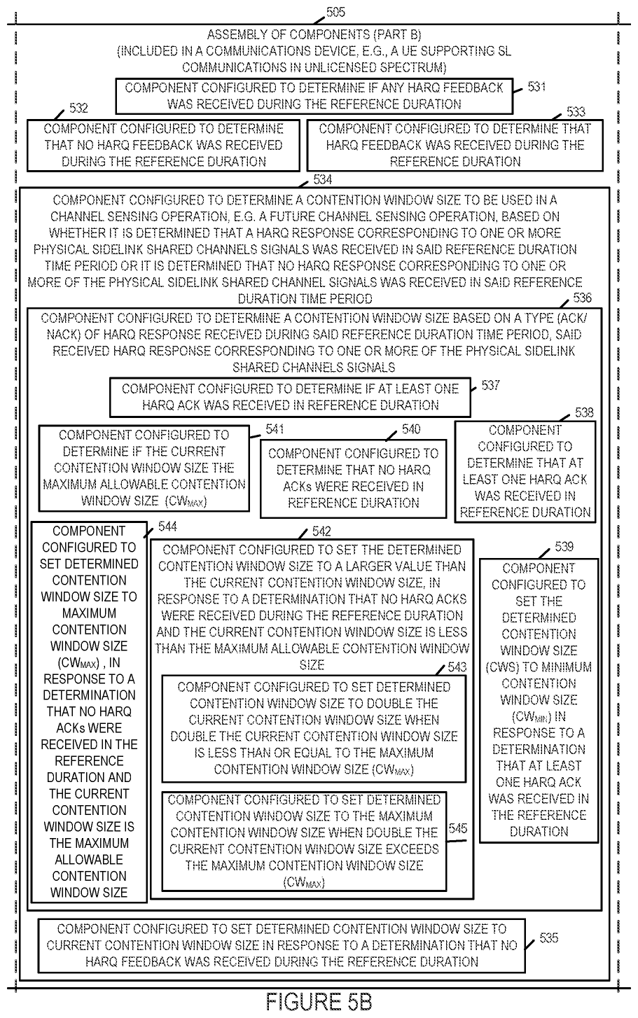

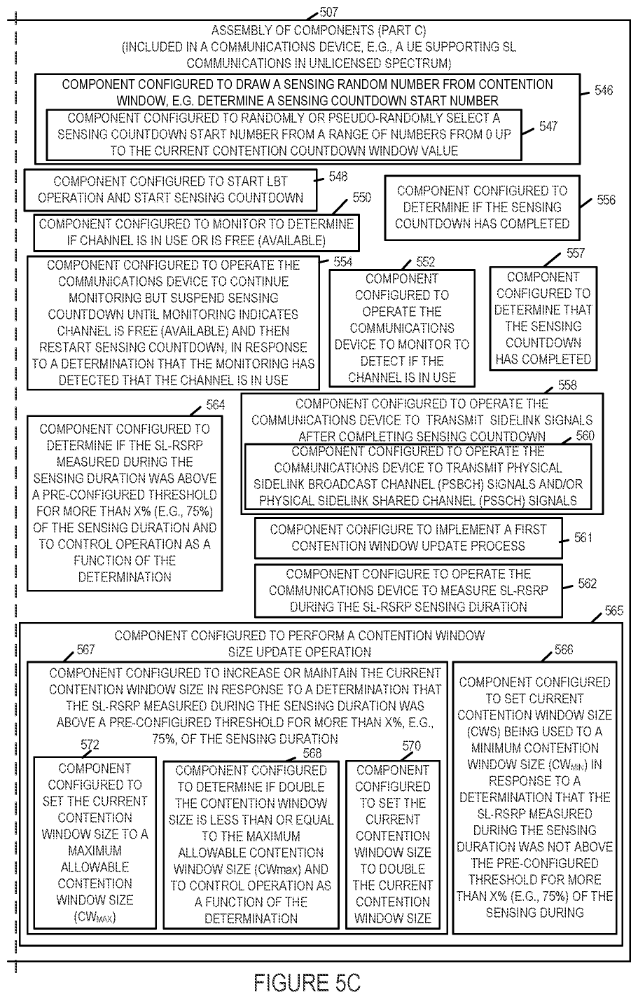

FIG. 5, comprising the combination of FIG. 5A, FIG. 5B, and FIG. 5C is a drawing of an exemplary assembly of components 500, comprising the combination of Part A 501, Part B 505 and Part C 507, which may be included in an exemplary communications device, e.g., communications device 400 of FIG. 4, in accordance with an exemplary embodiment.

The components in the assembly of components 500 can be, and in some embodiments are, implemented fully in hardware within a processor, e.g., processor 402, e.g., as individual circuits. The components in the assembly of components 500 can be, and in some embodiments are, implemented fully in hardware within the assembly of hardware components 414, e.g., as individual circuits corresponding to the different components. In other embodiments some of the components are implemented, e.g., as circuits, within processor 402 with other components being implemented, e.g., as circuits within assembly of components 414, external to and coupled to the processor 402. As should be appreciated, the level of integration of components on the processor and/or with some components being external to the processor may be one of design choice. Alternatively, rather than being implemented as circuits, all or some of the components may be implemented in software and stored in the memory 412 of the communications device 400, with the components controlling operation of communications device 400 to implement the functions corresponding to the components when the components are executed by a processor e.g., processor 402. In some such embodiments, the assembly of components 500 is included in the memory 412, as part of an assembly of software components 472. In still other embodiments, various components in assembly of components 500 are implemented as a combination of hardware and software, e.g., with another circuit external to the processor providing input to the processor which then under software control operates to perform a portion of a component's function.

When implemented in software the components include code, which when executed by a processor, e.g., processor 402, configure the processor to implement the function corresponding to the component. In embodiments where the assembly of components 500 is stored in the memory 412, the memory 412 is a computer program product comprising a computer readable medium comprising code, e.g., individual code for each component, for causing at least one computer, e.g., processor 402, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 5 control and/or configure the communications device 400 or elements therein such as the processor 402, to perform the functions of corresponding steps illustrated in the signaling diagrams and/or described with respect to any of the Figures. Thus, the assembly of components 500 includes various components that perform functions of corresponding one or more described and/or illustrated steps of an exemplary method, e.g., steps of the method of flowchart 300 of FIG. 3.

Assembly of components 500 includes a component 503 configured to determine an intended mode (unicast, groupcast, or broadcast) for transmission of PSSCH and PSCCH signals, a component 504 configured to control operation as a function of whether the determined intended mode of operation is unicast/groupcast or broadcast, a component 506 configured to set a current contention window to an initial value for unicast/groupcast modes, and a component 508 configured to set the current contention window to an initial value for broadcast mode.

Assembly of components 500 further includes a component 512 configured to draw a sensing random number from the current contention window, e.g., determine a sensing countdown start number. Component 512, in some embodiments, includes a component 513 configured to randomly or pseudo-randomly select a sensing countdown start number from a range of numbers from 0 up to the current contention countdown window value.

Assembly of components 500 further includes a component 514 configured to start listen-before-talk (LBT) operation and start sensing countdown using the selected sensing countdown start number, a component 516 configured to monitor to determine if the channel (SL channel) is in use or is free (available), a component 518 configured to determine whether or not the monitored channel is in use and to control operation as a function of the determination, a component 520 configured to continue monitoring but suspend sensing countdown until monitoring indicates the channel is free (available), and then restart the sensing countdown, in response to a determination that the monitored channel is in use, and a component 522 configured to determine whether or not the sensing countdown has completed and to control operation as a function of the determination.

Assembly of components 500 further includes a component configured to operate the communications device to transmit sidelink signals, e.g., PSCCH signals and PSSCH signals, after completion of the sensing countdown. Component 524 includes a component 526 configured to operate the communications device to transmit physical sidelink shared channels (PSSCH) signal.

Assembly of components 500 further includes a component 527 configured to implement a second contention window update process, e.g., for use when the mode is one of unicast mode or groupcast mode with regard to intended sidelink transmissions in unlicensed spectrum. In some embodiments, component 527 includes components 528, 529, 531, 532, 533, 534, 535 536, 537, 538, 539, 540, 541, 542, 543, 544, and 545.

Assembly of components 500 further includes a component 528 configured to operate the communications device to monitor for HARQ ACK/NACK (in response to one or more previous PSSCH transmissions by the communication device in a reference duration) on physical sidelink feedback channel (PSFCH) and/or on physical uplink shared channel (PUSCH), a component 529 configured to operate the communications device to exclude non-LBT sidelink sensing time from reference duration for contention window size (CWS) adjustment for unicast/multicast mode.

Assembly of components 500 further includes a component 530 configured to determine if any HARQ feedback was received during the reference duration, a component 531 configured to determine that no HARQ feedback was received during the reference duration, and a component 533 configured to determine that HARQ feedback was received during the reference duration, e.g., at least one HARQ ACK or one HARQ NACK was received on the PSFCH during the reference duration in response to a PSSCH signal previously transmitted by the communications device.

Assembly of components 500 further includes a component 534 configured to determine a contention window size to be used in a channel sensing operation, e.g., a future channel sensing operation, based on whether it is determined that a HARQ response corresponding to one or more physical sidelink shared channel signals was received in said reference duration time period or it is determined that no HARQ response corresponding to the one or more PSSCHs was received in said reference duration time period and a component 535 configured to set the determined contention window size to the current contention window size in response to a determination that no HARQ feedback was received during the reference duration.

Component 534 includes a component 536 configured to determine a contention window size based on a type (ACK/NACK) of HARQ response received during said reference duration time period, said received HARQ response corresponding to one or more of the physical sidelink shared channel signals.

Component 536 includes a component 537 configured to determine if at least one HARQ ACK was received in a reference duration, a component 538 configured to determine that at least one HARQ ACK was received in the reference duration, a component 539 configured to set the determined contention window size (CWS) to the minimum contention window size (CWmin) in response to a determination that at least one HARQ ACK was received in the reference duration, a component 540 configured to determine that no HARQ ACKs were received in the reference duration, e.g. one or more HARQ NACKs were received but no HARQ ACKs were received, a component 541 configured to determine if the current content window size if the maximum allowable contention window size (CWmax), a component 542 configured to set the determined contention window size to a larger value than the current contention window size, in response to a determination that no HARQ ACKs were received during the reference duration and the current contention window size is less than the maximum allowable contention window size, and a component 544 configured to set the determined contention window size to the maximum contention window size (CWmax), in response to a determination that no HARQ ACKs were received in the reference duration and the current contention window size is the maximum allowable contention window size. Component 542 includes a component 543 configured to set the determined contention window size to double the current contention window size when double the current contention window size is less than or equal to the maximum contention window size (CWmax), and a component 545 configured to set the determined contention window size to the maximum contention window size when double the current contention window size exceeds the maximum contention window size (CWmax).

Assembly of components 500 further includes a component 546 configured to draw a sensing random number from a current contention window, e.g., determine a sensing countdown start number. Component 546 includes a component 547 configured to randomly or pseudo-randomly select a sensing countdown start number for a range of numbers from 0 up to the current contention window value. Assembly of components further includes a component configured to start LBT operation and start sensing countdown using the selected sensing countdown start number, a component 550 configured to monitor to determine if channel (SL channel) is in use or is free (available), a component 552 configured to operate the communications device to monitor to detect if the channel is in use, a component 554 configured to operate the communications device to continue monitoring but suspend sensing countdown until monitoring indicates the channel is free (available) and then restart sensing countdown, in response to a determination that the monitoring has detected that the channel is in use, a component 556 configured to determine if the sensing countdown has completed, and a component 557 configured to determine that the sensing countdown has completed.

Assembly of components 500 further includes a component 558 configured to operate the communications device to transmit sidelink signals after completing the sensing countdown. Component 558 includes a component 560 configured to operate the communications device to transmit physical sidelink broadcast channel (PSBCH) signals and/or physical sidelink shared channel (PSSCH) signals.

Assembly of components 500 further includes a component 561 configured to implement a first contention window update process, e.g., for use when the mode is broadcast mode with regard to intended sidelink transmissions in unlicensed spectrum. In some embodiments component 561 includes components 562, 564, 565, 566, 567, 568, 570 and 572.

Assembly of components 500 further includes a component 562 configured to operate the communications device to measure SL-RSRP during the SL-RSRP sensing duration, a component 564 configured to determine if the SL-RSRP measured during the sensing duration (SL-RSRP sensing duration) was above a pre-configured threshold for than X % (e.g., 75%) of the sensing duration and to control operation as a function of the determination, and a component 565 configured to perform a contention window size update operation. Component 565 includes a component 566 configured to set the current contention window size (CWS) being used to a minimum contention window size (CWmin) in response to a determination that the SL-RSRP measured during the sensing duration was not above the pre-configured threshold for more than X % (e.g., 75%) of the sensing duration, and a component 567 configured to increase or maintain the current contention window size in response to a determination that the SL-RSRP measured during the sensing duration was above a pre-configured threshold for more than X % (e.g., 75%) of the sensing duration. Component 567 includes a component 568 configured to determine if double the current contention window size is less than or equal to the maximum allowable contention window size (CWmax) and to control operation as a function of the determination, a component 570 configured to set the current contention window size to double the current contention window size in response to a determination that double the current contention window size is less than or equal to the maximum allowable contention window size (CWmax), and a component 572 configured to set the current contention window size to a maximum allowable contention window size (CWmax) in response to a determination that double the current contention window size is not less than or equal to the maximum allowable contention window size (CWmax).

Various aspects and/or features of some embodiments of the present invention are further discussed below. Some exemplary embodiments are directed to user equipment (UE) control method and apparatus for controlling the SideLink-Unlicensed (SL-U) Listen-Before-Talk (LBT) Contention Window (CW) size for unicast, groupcast, and broadcast transmissions of physical sidelink shared channel (PSSCH), physical sidelink broadcast channel (PSBCH) and physical sidelink control channel (PSCCH).

For unicast and groupcast, the SL-U CW is reset to CWmin for all priority classes if at least one HARQ ACK was received for one or more PSSCH transmission within a reference duration, where the HARQ ACK feedback was either sent on PSFCH or on PUSCH to gNB. Otherwise, the CW is doubled to the next feasible value with CWmax as the maximum possible value. If no HARQ ACK feedback was received in the reference duration, the CW size is not changed.

The reference duration definition depends on the resource mode. For mode 2, the reference duration is defined as the duration of time between the end of its previous channel occupancy, excluding any non-LBT sensing time during which the UE was measuring SL-RSRP. For mode 1, the reference duration is defined as the duration of time between the end of its previous channel occupancy and the start of the current channel occupancy. An example is illustrated in FIG. 2.

For broadcast mode without HARQ ACK feedback, the SL-U CW is doubled to the next value with CWmax as the maximum possible value if the SL-RSRP measured during the sensing duration is above a pre-configured threshold for more than X % of the sensing (e.g., X=75), else the SL-U CW is reset to CWmin.

### First Numbered List of Exemplary Method Embodiments

Method Embodiment 1. A method of operating a communications device, the method comprising: transmitting (326) physical sidelink shared channel signals; monitoring (within a reference duration time period) (328) for HARQ responses to one or more of the transmitted physical sidelink shared channel signals; determining (331) if a HARQ response corresponding to one or more of the physical sidelink shared channel signals was received in a reference duration time period; and determining (334) a contention window size to use in a channel sensing operation (e.g., a future channel sensing operation) based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

Method Embodiment 2. The method of Method Embodiment 1, wherein determining (334) a contention window size to use in a channel sensing operation includes: setting (335) the determined contention window size to the current contention window size in response to determining (332) that no HARQ response corresponding to one or more of the physical sidelink shared channel signals was received in said reference duration time period.

Method Embodiment 3. The method of Method Embodiment 1, wherein determining (334) a contention window size to use in a channel sensing operation includes: determining (336) the contention window size based on a type (ACK/NACK) of HARQ response received during said reference duration time period, said received HARQ response corresponding to one or more of the physical sidelink shared channel signals.

Method Embodiment 4. The method of Method Embodiment 3, wherein determining (336) the contention window size based on a type of HARQ response received during said reference duration time period includes: determining (337) if at least one HARQ ACK was received during the reference duration time period.

Method Embodiment 5. The method of Method Embodiment 4, further comprising: setting (339) the determined contention window size to a minimum contention window size in response to determining (338) that at least one HARQ ACK was received during the reference duration time period.

Method Embodiment 6. The method of Method Embodiment 4, wherein determining (336) the contention window size based on a type of HARQ response received during said reference duration time period includes: setting (344) the determined contention window size to be the maximum allowable contention window size when current contention window size is the maximum allowable contention window size and at least one HARQ ACK was not received in the reference duration time period.

Method Embodiment 7. The method of Method Embodiment 4, wherein determining (336) the contention window size based on a type of HARQ response received during said reference duration time period includes: setting (342) the determined contention window size to a larger value than the current contention window size when the current contention window size is less than a maximum contention window size and when at least one HARQ ack was not received during the reference duration time period.

Method Embodiment 8. The method of Method Embodiment 7, wherein setting (342) the determined contention window size to a larger value than the current contention window size includes doubling (343) the current contention window size to create the determined contention window size when double the current contention window size is less than or equal to the maximum contention window size.

Method Embodiment 9. The method of Method Embodiment 7, wherein setting (342) the determined contention window size to a larger value than the current contention window size includes setting (345) the determined contention window size to the maximum contention window size when double the current contention window size exceeds the maximum permitted contention window size.

Method Embodiment 10. The method of Method Embodiment 1, wherein said physical sidelink shared channel signals are transmitted into unlicensed spectrum.

Method Embodiment 10A. The method of Method Embodiment 10, wherein said unlicensed spectrum is a band of 5 GHz spectrum or a band of 6 GHz spectrum.

### First Numbered List of Exemplary Apparatus Embodiments

Apparatus Embodiment 1. A communications device (400) comprising: a wireless transmitter (426); a wireless receiver (424); and a processor (402) configured to: operate the wireless transmitter (426) to transmit (326) physical sidelink shared channel signals; operate the communications device (400) to monitor (within a reference duration time period) (328) for HARQ responses (received via the wireless receiver (424)) to one or more of the transmitted physical sidelink shared channel signals; determine (331) if a HARQ response corresponding to one or more of the physical sidelink shared channel signals was received in a reference duration time period; and determine (334) a contention window size to use in a channel sensing operation (e.g., a future channel sensing operation) based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

Apparatus Embodiment 2. The communications device (400) of Apparatus Embodiment 1, wherein said processor (402) is configured to: set (335) the determined contention window size to the current contention window size in response to determining (332) that no HARQ response corresponding to one or more of the physical sidelink shared channel signals was received in said reference duration time period, as part of being configured to determine (334) a contention window size to use in a channel sensing operation.

Apparatus Embodiment 3. The communications device (400) of Apparatus Embodiment 1, wherein said processor (402) is configured to: determine (336) the contention window size based on a type (ACK/NACK) of HARQ response received during said reference duration time period, said received HARQ response corresponding to one or more of the physical sidelink shared channel signals, as part of being configured to determine (334) a contention window size to use in a channel sensing operation.

Apparatus Embodiment 4. The communications device (400) of Apparatus Embodiment 3, wherein said processor (402) is configured to: determine (337) if at least one HARQ ACK was received during the reference duration time period, as part of being configured to determine (336) the contention window size based on a type of HARQ response received during said reference duration time period.

Apparatus Embodiment 5. The communications device (400) of Apparatus Embodiment 4, wherein said processor (402) is configured to: set (339) the determined contention window size to a minimum contention window size in response to determining (338) that at least one HARQ ACK was received during the reference duration time period.

Apparatus Embodiment 6. The communications device (400) of Apparatus Embodiment 4, wherein said processor (402) is configured to: set (344) the determined contention window size to be the maximum allowable contention window size when current contention window size is the maximum allowable contention window size and at least one HARQ ACK was not received in the reference duration, as part of being configured to determine (336) the contention window size based on a type of HARQ response received during said reference duration time period.

Apparatus Embodiment 7. The communications device (400) of Apparatus Embodiment 4, wherein said processor (402) is configured to: set (342) the determined contention window size to a larger value than the current contention window size when the current contention window size is less than a maximum contention window size and when at least one HARQ ack was not received during the reference duration time period, as part of being configured to determine (336) the contention window size based on a type of HARQ response received during said reference duration time period.

Apparatus Embodiment 8. The communications device (400) of Apparatus Embodiment 7, wherein said processor (402) is configured to: double (343) the current contention window size to create the determined contention window size when double the current contention window size is less than or equal to the maximum contention window size, as part of being configured to set (342) the determined contention window size to a larger value than the current contention window size.

Apparatus Embodiment 9. The communications device (400) of Apparatus Embodiment 7, wherein said processor (402) is configured to: set (345) the determined contention window size to the maximum contention window size when double the current contention window size exceeds the maximum permitted contention window size, as part of being configured to set (342) the determined contention window size to a larger value than the current contention window size.

Apparatus Embodiment 10. The communications device (400) of Apparatus Embodiment 1, wherein said physical sidelink shared channel signals are transmitted into unlicensed spectrum.

Apparatus Embodiment 10A. The communications device (400) of Apparatus Embodiment 10, wherein said unlicensed spectrum is a band of 5 GHz spectrum or a band of 6 GHz spectrum.

### First Numbered List of Exemplary Non-Transitory Computer Readable Medium Embodiments

Non-Transitory Computer Readable Medium Embodiment 1.

A non-transitory computer readable medium (412) including machine executable instructions which when executed by a processor (402) of a communications device (400) control the communications device (400) to perform the steps of: transmitting (326) physical sidelink shared channel signals; monitoring (within a reference duration time period) (328) for HARQ responses to one or more of the transmitted physical sidelink shared channel signals; determining (331) if a HARQ response corresponding to one or more of the physical sidelink shared channel signals was received in a reference duration time period; and determining (334) a contention window size to use in a channel sensing operation (e.g., a future channel sensing operation) based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

### Second Numbered List of Exemplary Method Embodiments

Method Embodiment 1. A method of operating a communications device, the method comprising: measuring (362) sidelink-reference signal received power (SL-RSRP) during a sensing duration (e.g., a SL-RSRP sensing duration); examining (364) measured SL-RSRP to determine if the measured SL-RSRP during the sensing duration was above a predetermined threshold for more than a predetermined portion (e.g., 75% of the time in the sensing duration) of the sensing duration; and performing a contention window size update operation (365) including: i) setting (366) a current contention window size being used to a minimum contention window size in response to determining that the measured SL-RSRP was not above a predetermined threshold for more than a predetermined portion (e.g., 75% of the time in the sensing duration) of the sensing duration; and ii) increasing or maintaining (367) the current contention window size in response to determining that the measured SL-RSRP was above the predetermined threshold for more than a predetermined portion (e.g., 75% of the time in the sensing duration) of the sensing duration.

Method Embodiment 2. The method of Method Embodiment 1, wherein the method includes said step of increasing or maintaining (367) the current contention window size, said step of increasing or maintaining (367) the current contention window size including: setting (372) the current contention window size to a maximum allowable contention window size when double current the contention window size is not less than or equal to the maximum allowable contention window size; and setting (370) the current contention window size to double the current contention window size when double the current contention window size is less than or equal to the maximum allowable contention window size.

Method Embodiment 3. The method of Method Embodiment 1, further comprising: prior to measuring (362) SL-RSRP during a sensing duration, transmitting (358) sidelink signals (e.g., PSCCH signals and PSSCH signals) after completing the sensing countdown.

Method Embodiment 4. The method of Method Embodiment 3, further comprising: randomly or pseudo randomly selecting (347) a sensing countdown start number from a range of numbers from 0 up to the countdown window; and starting (348) a sensing countdown which uses the countdown start number as a starting value.

Method Embodiment 5. The method of Method Embodiment 4, further comprising: determining (357) that the sensing countdown has completed; and transmitting (358) sidelink signals after completing the sensing countdown.

Method Embodiment 6. The method of Method Embodiment 1, further comprising: determining (303) a mode of communications device operation, said mode being one of i) a unicast mode of operation, ii) a groupcast mode of operation or iii) a broadcast mode of operation; and when the mode of operation is to be determined to be a unicast mode or groupcast mode of operation, implementing (361) a first contention window update process; and when the mode of operation is to be determined to be a broadcast mode of operation, implementing (327) a second contention window update process.

Method Embodiment 6A. The method of Method Embodiment 6, wherein said mode of communications device operation is a transmission mode of operation with regard to transmitting sidelink signals (e.g., PSSCH signals and PSCCH signals or PSBCH signals).

Method Embodiment 7. The method of Method Embodiment 6, wherein said steps of: measuring (362) SL-RSRP during a sensing duration; examining (364) measured SL-RSRP to determine if the measured SL-RSRP during the sensing duration was above a predetermined threshold for more than a predetermined portion (e.g., 75% of the time in the sensing duration) of the sensing duration; and performing a contention window size update operation (365) are performed as part of operating in the broadcast mode of operation and are part of the first contention window update process (361).

Method Embodiment 8. The method of Method Embodiment 6, wherein the second contention window update process includes: determining (331) if a HARQ response corresponding to one or more of the physical sidelink shared channel signals was received in a reference duration time period; and determining (334) a contention window size to use in a channel sensing operation (e.g., a future channel sensing operation) based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

Method Embodiment 9. The method of Method Embodiment 1, wherein measuring (362) sidelink-reference signal received power (SL-RSRP) during a sensing duration (e.g., a SL-RSRP sensing duration) corresponds to measuring SL-RSRP across a band of unlicensed spectrum.

Method Embodiment 9A. The method of Method Embodiment 9, wherein said band of unlicensed spectrum is a band of 5 GHz spectrum or a band of 6 GHz spectrum.

### Second Numbered List of Exemplary Apparatus Embodiments

Apparatus Embodiment 1. A communications device (400) comprising: a wireless receiver (424); a wireless transmitter (426); and a processor (402) configured to: operate the communications device (400) to measure (362) sidelink-reference signal received power (SL-RSRP) during a sensing duration (e.g., a SL-RSRP sensing duration); examine (364) measured SL-RSRP to determine if the measured SL-RSRP during the sensing duration was above a predetermined threshold for more than a predetermined portion (e.g., 75% of the time in the sensing duration) of the sensing duration; and perform a contention window size update operation (365) including: i) setting (366) a current contention window size being used to a minimum contention window size in response to determining that the measured SL-RSRP was not above a predetermined threshold for more than a predetermined portion (e.g., 75% of the time in the sensing duration) of the sensing duration; and ii) increasing or maintaining (367) the current contention window size in response to determining that the measured SL-RSRP was above the predetermined threshold for more than a predetermined portion (e.g., 75% of the time in the sensing duration) of the sensing duration.

Apparatus Embodiment 2. The communications device (400) of Apparatus Embodiment 1, wherein increasing or maintaining (367) the current contention window size including: setting (372) the current contention window size to a maximum allowable contention window size when double current the contention window size is not less than or equal to the maximum allowable contention window size; and setting (370) the current contention window size to double the current contention window size when double the current contention window size is less than or equal to the maximum allowable contention window size.

Apparatus Embodiment 3. The communications device (400) of Apparatus Embodiment 1, wherein said processor (402) is configured to: operate the wireless transmitter (426) to transmit (358) sidelink signals (e.g., PSCCH signals and PSSCH signals) after completing the sensing countdown, said transmitting of sidelink signals being prior to said measuring (362) SL-RSRP during a sensing duration.

Apparatus Embodiment 4. The communications device (400) of Apparatus Embodiment 3, wherein said processor (402) is further configured to: randomly or pseudo randomly select (347) a sensing countdown start number from a range of numbers from 0 up to the countdown window; and start (348) a sensing countdown which uses the countdown start number as a starting value.

Apparatus Embodiment 5. The communications device (400) of Apparatus Embodiment 4, wherein said processor (402) is further configured to: determine (357) that the sensing countdown has completed; and operate the wireless transmitter (426) to transmit (358) sidelink signals after completing the sensing countdown.

Apparatus Embodiment 6. The communications device (400) of Apparatus Embodiment 1, wherein said processor is further configured to: determine (303) a mode of communications device operation, said mode being one of i) a unicast mode of operation, ii) a groupcast mode of operation or iii) a broadcast mode of operation; and when the mode of operation is determined to be a unicast mode or groupcast mode of operation, operate the communications device (400) to implement (361) a first contention window update process; and when the mode of operation is to be determined to be a broadcast mode of operation, operate the communications device (400) to implement (327) a second contention window update process.

Apparatus Embodiment 6A. The communications device (400) of Apparatus Embodiment 6, wherein said mode of communications device operation is a transmission mode of operation with regard to transmitting sidelink signals (e.g., PSSCH signals and PSCCH signals or PSBCH signals).

Apparatus Embodiment 7. The communications device (400) of Apparatus Embodiment 6, wherein said processor (402) is configured to perform said steps of: measuring (362) SL-RSRP during a sensing duration; examining (364) measured SL-RSRP to determine if the measured SL-RSRP during the sensing duration was above a predetermined threshold for more than a predetermined portion (e.g., 75% of the time in the sensing duration) of the sensing duration; and performing a contention window size update operation (365), as part of being configured to implement (361) a first contention window update process (and operating in a broadcast mode of operation).

Apparatus Embodiment 8. The communications device (400) of Apparatus Embodiment 6, wherein said processor (402) is configured to: determine (331) if a HARQ response corresponding to one or more of the physical sidelink shared channel signals was received in a reference duration time period; and determine (334) a contention window size to use in a channel sensing operation (e.g., a future channel sensing operation) based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period, as part of being configured to perform the second contention window update process.

Apparatus Embodiment 9. The communications device (400) of Apparatus Embodiment 1, wherein measuring (362) sidelink-reference signal received power (SL-RSRP) during a sensing duration (e.g., a SL-RSRP sensing duration) corresponds to measuring SL-RSRP across a band of unlicensed spectrum.

Apparatus Embodiment 9A. The communications device of Apparatus Embodiment 9, wherein said band of unlicensed spectrum is a band of 5 GHz spectrum or a band of 6 GHz spectrum.

### Second Numbered List of Exemplary Non-Transitory Computer Readable Medium Embodiments

Non-Transitory Computer Readable Medium Embodiment 1.

A non-transitory computer readable medium (412) including machine executable instructions which when executed by a processor (402) of a communications device (400) control the communications device (400) to perform the steps of: measuring (362) sidelink-reference signal received power (SL-RSRP) during a sensing duration (e.g., a SL-RSRP sensing duration); examining (364) measured SL-RSRP to determine if the measured SL-RSRP during the sensing duration was above a predetermined threshold for more than a predetermined portion (e.g., 75% of the time in the sensing duration) of the sensing duration; and performing a contention window size update operation (365) including: i) setting (366) a current contention window size being used to a minimum contention window size in response to determining that the measured SL-RSRP was not above a predetermined threshold for more than a predetermined portion (e.g., 75% of the time in the sensing duration) of the sensing duration; and ii) increasing or maintaining (367) the current contention window size in response to determining that the measured SL-RSRP was above the predetermined threshold for more than a predetermined portion (e.g., 75% of the time in the sensing duration) of the sensing duration.

Various embodiments are directed to apparatus, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, etc., other network communications devices such as routers, switches, etc., mobile network operator (MNO) base stations (macro cell base stations and small cell base stations) such as a Evolved Node B (eNB), gNB or ng-eNB, mobile virtual network operator (MVNO) base stations such as Citizens Broadband Radio Service Devices (CBSDs), network nodes, MNO and MVNO HSS devices, relay devices, e.g. mobility management entities (MMEs), a Spectrum Access System (SAS), an AFC system, an Access and Mobility Management Function (AMF) device, servers, customer premises equipment devices, cable systems, network nodes, gateways, cable headend and/or hubsites, network monitoring nodes and/or servers, cluster controllers, cloud nodes, production nodes, cloud services servers and/or network equipment devices. Various embodiments are also directed to methods, e.g., method of controlling and/or operating access points (APs), e.g., WiFi APs, base stations such as NRU gNB base stations, etc., user devices such as stations (STAs), e.g., WiFi STAs, user equipment (UE) devices, LTE LAA devices, various types of RLAN devices, network communications devices such as routers, switches, etc., user devices, base stations, e.g., eNB and CBSDs, gateways, servers (HSS server), MMEs, SAS, an AFC system, cable networks, cloud networks, nodes, servers, cloud service servers, customer premises equipment devices, controllers, network monitoring nodes and/or servers and/or cable or network equipment devices. Various embodiments are directed to communications network which are partners, e.g., a MVNO network and a MNO network. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements are steps are implemented using hardware circuitry.

In various embodiments nodes and/or elements described herein are implemented using one or more components to perform the steps corresponding to one or more methods, for example, message reception, message generation, signal generation, signal processing, sending, comparing, determining and/or transmission steps. Thus, in some embodiments various features are implemented using components or in some embodiment's logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., an access points (AP), e.g., WiFi AP, base stations such as NRU gNB base station, etc., a user device such as a station (STA), e.g., WiFi STA, a user equipment (UE) device, LTE LAA device, etc., an RLAN device, other network communications devices a network communications device such as router, switch, etc., a MVNO base station such as a CBRS base station, e.g., a CBSD, a device such as a cellular base station e.g., an eNB, a MNO HSS server, a MVNO HSS server, a UE device, a relay device, e.g. a MME, SAS, a AFC system, etc., said device including a processor configured to implement one, multiple or all of the steps of one or more methods of the invention.

In some embodiments, the processor or processors, e.g., CPUs, of one or more devices, e.g., communications nodes such as e.g., access points (APs), e.g., WiFi APs, base stations such as NRU gNB base stations, etc., user devices such as stations (STAs), e.g., WiFi STAs, user equipment (UE) devices, LTE LAA devices, etc., various RLAN devices, network communications devices such as routers, switches, etc., a MVNO base station such as a CBRS base station, e.g. a CBSD, an device such as a cellular base station e.g., an eNB, a MNO HSS server, a MVNO HSS device server, a UE device, a relay device, e.g. a MME, a SAS, a AFC system, are configured to perform the steps of the methods described as being performed by the communications nodes, e.g., controllers. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., an access points (AP), e.g., WiFi AP, a base station such as NRU gNB base station, etc., a user device such as station (STA), e.g., WiFi STA, a user equipment (UE) device, an LTE LAA device, etc., a RLAN device, a network communications device such as router, switch, etc, administrator device, security device, a MVNO base station such as a CBRS base station, e.g. a CBSD, an device such as a cellular base station e.g., an eNB, a MNO HSS server, a MVNO HSS device server, a UE device, a relay device, e.g. a MME, includes a component corresponding to each of one or more of the steps of the various described methods performed by the device in which the processor is included. In some but not all embodiments a device, e.g., a communications node such as e.g., an access points (AP), e.g., WiFi AP, a base station such as NRU gNB base station, etc., a user device such as a station (STA), e.g., WiFi STA, a user equipment (UE) device, a LTE LAA device, a RLAN device, a router, switch, etc., administrator device, security device, a AFC system, a MVNO base station such as a CBRS base station, e.g., a CBSD, a device such as a cellular base station e.g., an eNB, an MNO HSS server, a MVNO HSS device server, a UE device, a relay device, e.g. a MME, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a communications nodes such as e.g., an access point (AP), e.g., WiFi AP, a base station such as NRU gNB base station, etc., a user device such as a station (STA), e.g., WiFi STA, a user equipment (UE) device, a LTE LAA device, etc., an RLAN device, a network communications device such as router, switch, etc., administrator device, security device, a AFC system, MNVO base station, e.g., a CBSD, an MNO cellular base station, e.g., an eNB or a gNB, a HSS server, a UE device, a SAS or other device described in the present application. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a communications device, the method comprising:
transmitting physical sidelink shared channel signals;
monitoring for HARQ responses to one or more of the transmitted physical sidelink shared channel signals;
determining if a HARQ response corresponding to one or more of the physical sidelink shared channel signals was received in a reference duration time period; and
determining a contention window size to use in a channel sensing operation based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

2. The method of claim 1, wherein determining a contention window size to use in a channel sensing operation includes:
setting the determined contention window size to the current contention window size in response to determining that no HARQ response corresponding to one or more of the physical sidelink shared channel signals was received in said reference duration time period.

3. The method of claim 1, wherein determining a contention window size to use in a channel sensing operation includes:
determining the contention window size based on a type of HARQ response received during said reference duration time period, said received HARQ response corresponding to one or more of the physical sidelink shared channel signals.

4. The method of claim 3, wherein determining the contention window size based on a type of HARQ response received during said reference duration time period includes:
determining if at least one HARQ ACK was received during the reference duration time period.

5. The method of claim 4, further comprising:
setting the determined contention window size to a minimum contention window size in response to determining that at least one HARQ ACK was received during the reference duration time period.

6. The method of claim 4, wherein determining the contention window size based on a type of HARQ response received during said reference duration time period includes:
setting the determined contention window size to be the maximum allowable contention window size when current contention window size is the maximum allowable contention window size and at least one HARQ ACK was not received in the reference duration time period.

7. The method of claim 4, wherein determining the contention window size based on a type of HARQ response received during said reference duration time period includes:
setting the determined contention window size to a larger value than the current contention window size when the current contention window size is less than a maximum contention window size and when at least one HARQ ack was not received during the reference duration time period.

8. The method of claim 7, wherein setting the determined contention window size to a larger value than the current contention window size includes doubling the current contention window size to create the determined contention window size when double the current contention window size is less than or equal to the maximum contention window size.

9. The method of claim 7, wherein setting the determined contention window size to a larger value than the current contention window size includes setting the determined contention window size to the maximum contention window size when double the current contention window size exceeds the maximum permitted contention window size.

10. The method of claim 1, wherein said physical sidelink shared channel signals are transmitted into unlicensed spectrum.

11. A communications device comprising:
a wireless transmitter;
a wireless receiver; and
a processor configured to:
operate the wireless transmitter to transmit physical sidelink shared channel signals;
operate the communications device to monitor for HARQ responses to one or more of the transmitted physical sidelink shared channel signals;
determine if a HARQ response corresponding to one or more of the physical sidelink shared channel signals was received in a reference duration time period; and
determine a contention window size to use in a channel sensing operation based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

12. The communications device of claim 11, wherein said processor is configured to:
set the determined contention window size to the current contention window size in response to determining that no HARQ response corresponding to one or more of the physical sidelink shared channel signals was received in said reference duration time period, as part of being configured to determine a contention window size to use in a channel sensing operation.

13. The communications device of claim 11, wherein said processor is configured to:
determine the contention window size based on a type of HARQ response received during said reference duration time period, said received HARQ response corresponding to one or more of the physical sidelink shared channel signals, as part of being configured to determine a contention window size to use in a channel sensing operation.

14. The communications device of claim 13, wherein said processor is configured to:
determine if at least one HARQ ACK was received during the reference duration time period, as part of being configured to determine the contention window size based on a type of HARQ response received during said reference duration time period.

15. The communications device of claim 14, wherein said processor is configured to:
set the determined contention window size to a minimum contention window size in response to determining that at least one HARQ ACK was received during the reference duration time period.

16. A method of operating a communications device, the method comprising:
measuring sidelink-reference signal received power (SL-RSRP) during a sensing duration;
examining measured SL-RSRP to determine if the measured SL-RSRP during the sensing duration was above a predetermined threshold for more than a predetermined portion of the sensing duration; and
performing a contention window size update operation including:
i) setting a current contention window size being used to a minimum contention window size in response to determining that the measured SL-RSRP was not above a predetermined threshold for more than a predetermined portion of the sensing duration; and
ii) increasing or maintaining the current contention window size in response to determining that the measured SL-RSRP was above the predetermined threshold for more than a predetermined portion of the sensing duration.

17. The method of claim 16, wherein the method includes said step of increasing or maintaining the current contention window size, said step of increasing or maintaining the current contention window size including:
setting the current contention window size to a maximum allowable contention window size when double current the contention window size is not less than or equal to the maximum allowable contention window size; and
setting the current contention window size to double the current contention window size when double the current contention window size is less than or equal to the maximum allowable contention window size.

18. The method of claim 16, further comprising:
prior to measuring SL-RSRP during a sensing duration, transmitting sidelink signals after completing the sensing countdown.

19. The method of claim 18, further comprising:
randomly or pseudo randomly selecting a sensing countdown start number from a range of numbers from 0 up to the countdown window; and
starting a sensing countdown which uses the countdown start number as a starting value.

20. The method of claim 19, further comprising:
determining that the sensing countdown has completed; and
transmitting sidelink signals after completing the sensing countdown.

21. The method of claim 16, further comprising:
determining a mode of communications device operation, said mode being one of i) a unicast mode of operation, ii) a groupcast mode of operation or iii) a broadcast mode of operation; and
when the mode of operation is to be determined to be a unicast mode or groupcast mode of operation, implementing a first contention window update process; and
when the mode of operation is to be determined to be a broadcast mode of operation, implementing a second contention window update process.

22. The method of claim 21, wherein said steps of: measuring SL-RSRP during a sensing duration; examining measured SL-RSRP to determine if the measured SL-RSRP during the sensing duration was above a predetermined threshold for more than a predetermined portion of the sensing duration; and performing a contention window size update operation are performed as part of operating in the broadcast mode of operation and are part of the first contention window update process.

23. The method of claim 21, wherein the second contention window update process includes:
determining if a HARQ response corresponding to one or more of the physical sidelink shared channel signals was received in a reference duration time period; and
determining a contention window size to use in a channel sensing operation based on whether it is determined that a HARQ response corresponding to one or more of the physical sidelink shared channel signals was received in said reference duration time period or it is determined that no HARQ response corresponding to one or more of the physical sidelink shared channel signals was received in said reference duration time period.

24. The method of claim 16, wherein measuring sidelink-reference signal received power (SL-RSRP) during a sensing duration corresponds to measuring SL-RSRP across a band of unlicensed spectrum.

25. A communications device comprising:
a wireless receiver;
a wireless transmitter; and
a processor configured to:
operate the communications device to measure sidelink-reference signal received power (SL-RSRP) during a sensing duration;
examine measured SL-RSRP to determine if the measured SL-RSRP during the sensing duration was above a predetermined threshold for more than a predetermined portion of the sensing duration; and
perform a contention window size update operation including:
i) setting a current contention window size being used to a minimum contention window size in response to determining that the measured SL-RSRP was not above a predetermined threshold for more than a predetermined portion of the sensing duration; and
ii) increasing or maintaining the current contention window size in response to determining that the measured SL-RSRP was above the predetermined threshold for more than a predetermined portion of the sensing duration.

26. The communications device of claim 25, wherein increasing or maintaining the current contention window size includes:
setting the current contention window size to a maximum allowable contention window size when double current the contention window size is not less than or equal to the maximum allowable contention window size; and
setting the current contention window size to double the current contention window size when double the current contention window size is less than or equal to the maximum allowable contention window size.

27. The communications device of claim 25, wherein said processor is configured to:
operate the wireless transmitter to transmit sidelink signals after completing the sensing countdown, said transmitting of sidelink signals being prior to said measuring SL-RSRP during a sensing duration.

28. The communications device of claim 3, wherein said processor is further configured to:
randomly or pseudo randomly select a sensing countdown start number from a range of numbers from 0 up to the countdown window; and
start a sensing countdown which uses the countdown start number as a starting value.

29. The communications device of claim 28, wherein said processor is further configured to:
determine that the sensing countdown has completed; and
operate the wireless transmitter to transmit sidelink signals after completing the sensing countdown.

30. The communications device of claim 25, wherein said processor is further configured to:
determine a mode of communications device operation, said mode being one of i) a unicast mode of operation, ii) a groupcast mode of operation or iii) a broadcast mode of operation; and
when the mode of operation is determined to be a unicast mode or groupcast mode of operation, operate the communications device to implement a first contention window update process; and
when the mode of operation is to be determined to be a broadcast mode of operation, operate the communications device to implement a second contention window update process.
